(19) United States
(12) Patent Application Publication
(10) Pub. No.: US 2025/0166173 A1
(43) Pub. Date: May 22, 2025

(54) METHOD AND SYSTEM OF ANALYSING BLOOD SMEAR IMAGE USING DEEP LEARNING MODEL

(71) Applicant: L&T TECHNOLOGY SERVICES LIMITED, Chennai (IN)

(72) Inventors: AKSHAYA POOTHANAPPILLI BABU, Ernakulam (IN); NISARGA KRISHNEGOWDA, Mysore (IN)

(21) Appl. No.: 18/605,971

(22) Filed: Mar. 15, 2024

(30) Foreign Application Priority Data
Nov. 21, 2023 (IN) 202341079763

(51) Int. Cl. G06T 7/00; G06T 7/13; G06T 7/44

(52) U.S. Cl. CPC G06T 7/0012; G06T 7/13; G06T 7/44; G06T 2207/20081; G06T 2207/30024

(57) ABSTRACT

A method and a system of analysing blood smear image is disclosed. A processor detects a plurality of blood cells in the blood smear image based on edge detection of the plurality of blood cells. The contours of each of the plurality of blood cells are determined based on the edge detection. A bounding box for each of the plurality of blood-cells is determined. Each blood cell is classified as one of white blood cells (WBC) or a red blood cell (RBC) using a deep learning model. A count of WBCs, a count of RBCs and volumetric information of the RBCs and the WBCs based on the classification and the contours of each of the plurality of blood-cells. A report is output comprising the count of WBCs, the count of RBCs or the volumetric information of the RBCs and WBCs.

### TECHNICAL FIELD

This disclosure relates generally to deep learning-based classification methodology and more particularly to a method and a system of analysing blood smear image using deep learning model.

### BACKGROUND

A comprehensive blood cell count holds immense significance in the field of medical diagnosis as it provides valuable insights into an individual's overall health status. The data associated with blood counts and related parameters can detect even minor health issues within the body. Traditionally, the process of conducting a comprehensive blood cell count involves manual counting using equipment like a hemacytometer, in conjunction with various laboratory instruments and chemical reagents. However, this manual method is not only time-consuming but also labor-intensive.

Furthermore, over time, advancements in image processing technology have revolutionized blood cell diagnostics. These innovations involve the analysis of blood smear images, significantly enhancing the accuracy and efficiency of blood cell diagnosis while yielding more precise results within a shorter timeframe. However, it is essential to note that some of these technologies are limited in scope and may focus solely on counting either white blood cells (WBC) or red blood cells (RBC), leaving a noticeable gap in the diagnostic field. This limitation highlights the need for more comprehensive solutions capable of analysing blood smear images, which encompass both WBC and RBC, to provide a more holistic diagnostic assessment.

Therefore, there is a requirement for an efficient and effective methodology for analysing blood smear images.

### SUMMARY OF THE INVENTION

In an embodiment, a method for analysing a blood smear image is disclosed. The method may include detecting, by a processor, a plurality of blood cells in the blood smear image based on edge detection of the plurality of blood cells. In an embodiment the edge detection of the plurality of blood cells in the blood smear image may be based on a preprocessing of the blood smear image. The method may further include, determining by the processor, contours of each of the plurality of blood cells based on the edge detection of the plurality of blood cells. The method may further include determining by the processor a bounding box for each of the plurality of blood-cells based on the contours of each of the plurality of blood-cells. The method may further include classifying by the processor, each of the plurality of blood-cells as one of a white blood cell (WBC) or a red blood cell (RBC) using a deep learning model. In an embodiment the deep learning model may be trained based on training data that may include a plurality of images of WBCs and RBCs. The method may further include determining by the processor, a count of WBCs, a count of RBCs and volumetric information of the RBCs and the WBCs based on the classification and the contours of each of the plurality of blood-cells. The method may further include outputting by the processor, a report that may include the count of WBCs, the count of RBCs or the volumetric information of the RBCs and the WBCs.

In another embodiment, a system of analysing a blood smear image is disclosed. The system may include a processor, a memory communicably coupled to the processor, wherein the memory may store processor-executable instructions, which when executed by the processor may cause the processor to detect a plurality of blood cells in the blood smear image based on edge detection of the plurality of blood cells. In an embodiment, the edge detection of the plurality of the blood cell in the blood smear image may be based on a preprocessing of the blood smear image. The processor may further determine contours of each of the plurality of blood cells based on the edge detection of the plurality of blood cells. The processor may further determine a bounding box for each of the plurality of blood-cells based on the contours of each of the plurality of blood-cells. The processor may further use a deep learning model to classify each of the plurality of blood-cells as one of a white blood cell (WBC) or a red blood cell (RBC) using a deep learning model. In an embodiment the deep learning model may be trained based on training data that may include a plurality of images of WBCs and RBCs. The processor may further determine a count of WBCs, a count of RBCs and volumetric information of the RBCs and the WBCs based on the classification and the contours of each of the plurality of blood-cells. The processor may further output a report that may include the count of WBCs, the count of RBCs or the volumetric information of the RBCs and the WBCs.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of an exemplary blood smear analysis system for analysing a blood smear image, in accordance with some embodiments of the present disclosure.

FIG. 2 is a functional block diagram of the analysing device, in accordance with some embodiments of the present disclosure.

FIG. 3A illustrates an exemplary blood smear image, in accordance with an embodiment of the present disclosure.

FIG. 3B illustrates an exemplary enhanced blood smear image, in accordance with an embodiment of the present disclosure.

FIG. 3C illustrates an exemplary filtered blood smear image, in accordance with an embodiment of the present disclosure.

FIG. 3D illustrates an exemplary bimodal blood smear image, in accordance with an embodiment of the present disclosure.

FIG. 3E illustrates an exemplary edge detected blood smear image, in accordance with an embodiment of the present disclosure.

FIG. 4A illustrates an exemplary contour determined blood smear image, in accordance with an embodiment of the present disclosure.

FIG. 4B illustrates an exemplary blood smear image depicting bounding boxes, in accordance with an embodiment of the present disclosure.

FIG. 5 illustrates a flow diagram of a methodology of generating training data, in accordance with an embodiment of the present disclosure.

FIG. 6 illustrates a flow diagram of a method of analysing a blood smear image, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims.

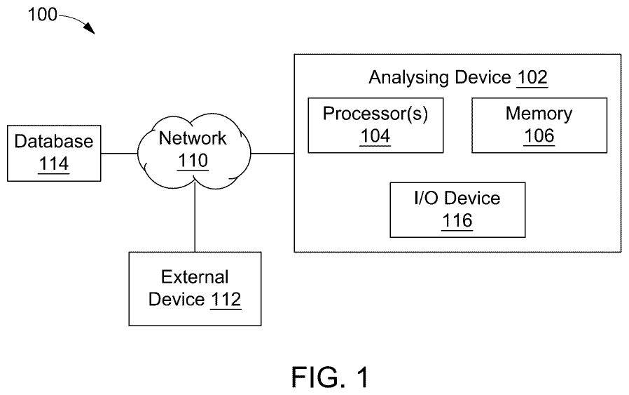

Referring now to FIG. 1, a block diagram of an exemplary blood smear analysis system 100 for analysing a blood smear image is illustrated, in accordance with some embodiment of the present disclosure. The blood smear analysis system 100 may include an analysing device 102, an external device 112, and a database 114 communicably coupled to each other through a wired or a wireless communication network 110. The analysing device 102 may include a processor 104, a memory 106 and an input/output (I/O) device 116. In an embodiment, examples of processor(s) 104 may include, but are not limited to, an Intel® Itanium® or Itanium 2 processor(s), or AMD® Opteron® or Athlon MP® processor(s), Motorola® lines of processors, Nvidia®, FortiSOC™ system on a chip processors or other future processors. In an embodiment, the memory 106 may store instructions that, when executed by the processor 104, and cause the processor 104 to analyze blood smear images, as discussed in more detail below. In an embodiment, the memory 106 may be a non-volatile memory or a volatile memory. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the I/O device 116 may comprise of variety of interface(s), for example, interfaces for data input and output devices, and the like. The I/O device 116 may facilitate inputting of instructions by a user communicating with the analyzing device 102. In an embodiment, the I/O device 116 may be wirelessly connected to the analyzing device 102 through wireless network interfaces such as Bluetooth®, infrared, or any other wireless radio communication known in the art. In an embodiment, the I/O device 116 may be connected to a communication pathway for one or more components of the analyzing unit 102 to facilitate the transmission of inputted instructions and output results of data generated by various components such as, but not limited to, processor(s) 104 and memory 106.

In an embodiment, the database 114 may be enabled in a cloud or a physical database and may store blood smear images and training data. In an embodiment, the training data may include a plurality of images of WBCs and RBCs that may be output by the analyzing device 102. In an embodiment, the database 114 may store data input by an external device 112 or output generated by the analyzing device 102. In an embodiment, the I/O device 116 may include an imaging device (not shown). In an embodiment, the imaging device may generally include one or more cameras, such as high-resolution camera to generate an input blood smear image from the given blood smear. Further, in some embodiment, the database 114 may include the images generated by the imaging device.

In an embodiment, the communication network 110 may be a wired or a wireless network or a combination thereof. The network 110 can be implemented as one of the different types of networks, such as but not limited to, ethernet IP network, intranet, local area network (LAN), wide area network (WAN), the internet, Wi-Fi, LTE network, CDMA network, 5G and the like. Further, network 110 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further network 110 can include a variety of network devices, including routers, bridges, servers, computing devices, storage devices, and the like.

In an embodiment, the analysing device 102 may receive a request for analysing blood smear image from the external device 112 through the network 110. In an embodiment, the analysing device 102 and the external device 112 may be a computing system, including but not limited to, a smart phone, a laptop computer, a desktop computer, a notebook, a workstation, a portable computer, a personal digital assistant, a handheld, a scanner, or a mobile device. In an embodiment, the analyzing device 102 may be, but not limited to, in-built into the external device 112 or may be a standalone computing device.

In an embodiment, the analysing device 102 may perform various processing for analysing the blood smear image. By way of an example, the analysing device 102 may receive the blood smear image. Further the analysing device 102 may detect a plurality of blood cells in the blood smear image based on edge detection of the plurality of blood cells. In an embodiment, blood may include, but not limited to, platelets, white blood cells (WBCs), red blood cells (RBCs), etc. In an embodiment, the edge detection of the plurality of blood cells in the blood smear image may be based on a pre-processing of the blood smear image by analysing device 102. The pre-processing may include contrast enhancing of the blood smear image using a contrast enhancement technique such as, but not limited to, histogram equalization technique, etc. The preprocessing may further include removing noise in the contrast enhanced blood smear image using a noise removing technique such as, but not limited to, gaussian filter, etc. In an embodiment, the edges of each of the plurality of blood cells may be determined by determining a bimodal image of the blood smear image upon the preprocessing. In an embodiment, the edges of each of the plurality of blood cells may be determined based on the bimodal image by using an edge detection technique.

The analysing device 102 may further determine a bounding box for each of the plurality of blood-cells based on the contours of each of the plurality of the blood cells.

Further, the analysing device 102 may use a deep learning model to classify each of the plurality of the blood cells as one of a white blood cell (WBC) or a red blood cell (RBC). In an embodiment, each of the plurality of blood-cells classified as the WBC, may be classified as one of a plurality of WBC classes using the deep learning model. In an embodiment, the each of the plurality of WBC classes may correspond to a type of WBC from a plurality of WBC types.

In an embodiment, the deep learning model may be trained based on training data that may include a plurality of images of WBCs and RBCs. In an embodiment, the training data may be generated by the analysing device 102 based on an input of at least one training image to the deep learning model. In an embodiment, the at least one training image may include at least one WBC and/or at least one RBC. Further, the training data may be generated by the analysing device 102 by determining bounding boxes for each of the at least one WBC and/or the at least one RBC based on detection of contours of the at least one WBC and the at least one RBC in the at least one training image.

Further, the training data may be generated by the processor 104 by cropping each of the bounding boxes to determine at least one WBC image and at least one RBC image. Further, the training data may be generated by the analysing device 102 by generating a first set of samples corresponding to WBCs and a second set of samples corresponding to RBCs based on the at least one WBC image and the at least one RBC image respectively using a generator model of the deep learning model. The analysing device 102 may generate the first set of samples and the second set of samples based on classification of each sample as one of real sample or fake sample using a discriminator model of the deep learning model. Further, the samples corresponding to the first set of samples and the second set of samples may be generated until the first set of samples may be balanced with respect to the second set of samples and each of the first set of samples and the second set of samples may be classified as real by the discriminator model. The plurality of images of WBCs and RBCs may be determined based on the first set of samples and the second set of samples respectively.

The analysing device 102 may further determine a count of WBCs, a count of RBCs and volumetric information of the RBCs and the WBCs based on the classification and the contours of each of the plurality of the blood cells. The examples of deep learning models may include but are not limited to, Convolution neural network (CNN), Recurrent neural network (RNN), Feed forward neural network (FNN), Generative Adversarial Network (GAN), External Classifier GAN, etc.

In an embodiment, the analyzing device 102 may further output a report on the I/O device 116 that may include the count of WBCs, the count of RBCs or the volumetric information of the RBCs and the WBCs. The analysing device 102 may further input the report as a query to a generative artificial intelligence-based query system via the communication network 110. The analysing device 102 may further display an analysis received from the generative artificial intelligence-based query system on a display screen of the I/O device 116. The analysis may be based on the count of WBCs, the count of RBCs or the volumetric information of the RBCs and WBCs. The analysis may include one or more health conditions that may be determined based on a comparison of the count of WBCs, the count of RBCs or the volumetric information of the RBCs and the WBCs with a corresponding predefined threshold count of WBCs, a predefined threshold count of RBCs or a predefined volumetric threshold of RBCs and WBCs.

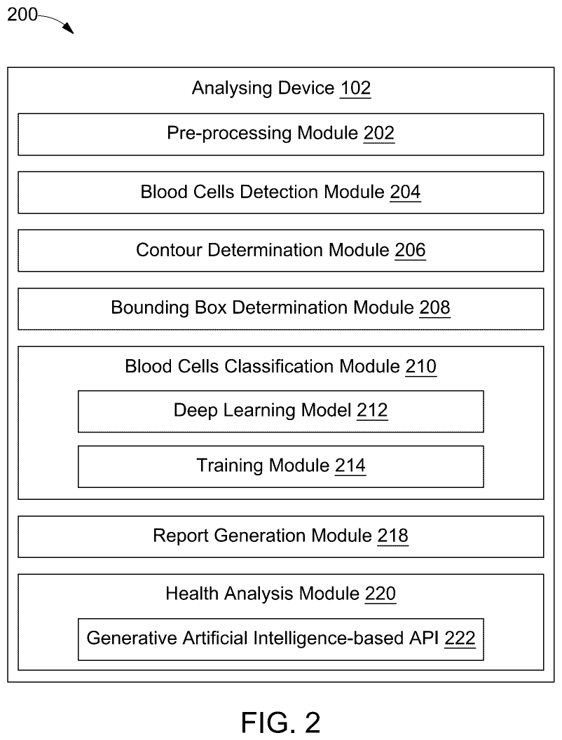

Referring now to FIG. 2, a functional block diagram of the analysing device 102, in accordance with some embodiments of the present disclosure. In an embodiment, the analysing device 102 may include a pre-processing module 202, a blood cells detection module 204, a contour determination module 206, a bounding box determination module 208, a blood cells classification module 210, a cells count determination module 214, a volumetric information determination module 214, a report generation module 216 and a health analysis module 218.

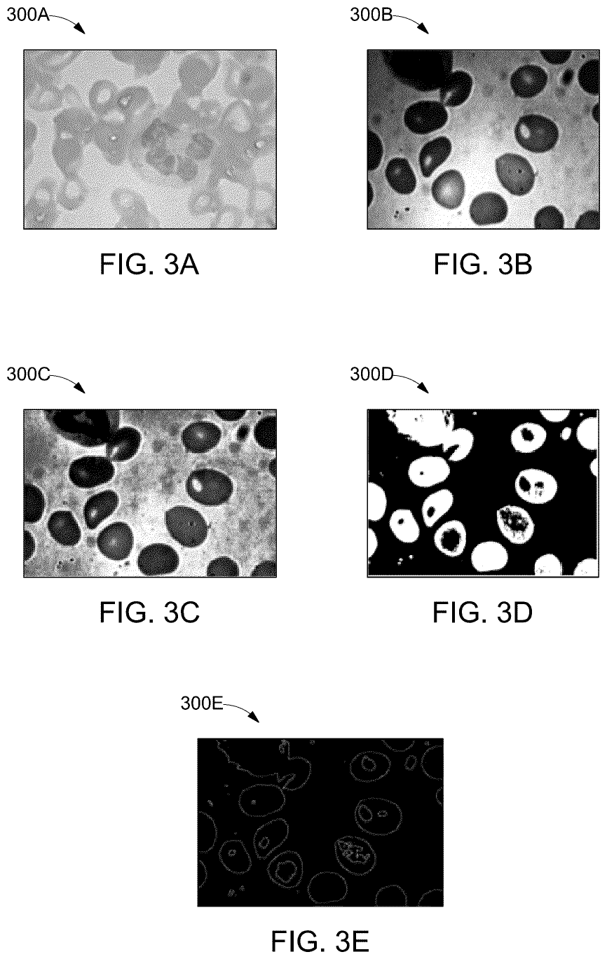

The analysing device 102 may receive a blood smear image from the I/O device 116. Referring now to FIG. 3A, an exemplary blood smear image 300A is depicted, in accordance with some embodiments of the present disclosure. The blood smear image 300A may include a plurality of blood-cells such as, but not limited to, RBCs, WBCs, etc. Referring back to FIG. 2, the preprocessing module 202 may preprocess the blood smear image 300A. The preprocessing may include contrast enhancing of the blood smear image using a histogram equalization technique. In an embodiment, the histogram equalization technique may be, but is not limited to, multiscale histogram equalization, bi-histogram equalization, adaptive histogram equalization, modified histogram equalization, entropy-based histogram equalization, etc. In an embodiment, the histogram equalization technique may be used to enhance contrast and improve the visibility of details in the blood smear image 300A by redistributing the intensity levels of the blood smear image's pixels so that the resulting histogram may be uniform. Referring now to FIG. 3B, an exemplary enhanced blood smear image 300B is illustrated, in accordance with an embodiment of the present disclosure. In an embodiment, the blood smear image 300A of FIG. 3A may be preprocessed to enhance its contrast using the histogram equalization technique to determine the contrast enhanced blood smear image 300B.

Referring back to FIG. 2, the preprocessing module 202 may further remove noise in the contrast enhanced blood smear image 300B using a noise removing technique such as, but not limited to, using a gaussian filter. In an embodiment, the gaussian filter used, may be but is not limited to, anisotropic gaussian filter, standard gaussian filter, separable gaussian filter, recursive gaussian filter, etc. In an embodiment, the gaussian filter may be used to reduce noise and smooth or blur the contrast enhanced image 300B. It should be noted that the gaussian filter based noise removing technique may be effective in preserving the edges and structure of the blood cells in the contrast enhanced blood smear image 300B while reducing high-frequency noise. Referring now to FIG. 3C, an exemplary filtered blood smear image 300C is illustrated, in accordance with an embodiment of the present disclosure. In an embodiment, the gaussian filter may be used to remove noise in the contrast enhanced blood smear image 300B to smoothen the enhanced blood smear image 300B and determine a noise filtered blood smear image 300C.

Referring now to FIG. 2, the blood cells detection module 204 may detect a plurality of blood cells in the noise filtered blood smear image 300C based on edge detection of the plurality of blood cells. In an embodiment, the edge detection of the plurality of blood cells in the noise filtered blood smear image 300C may be performed to determine the plurality of blood cells.

In an embodiment, the blood cells detection module 204 may determine the edges of each of the plurality of blood cells by determining a bimodal image of the noise filtered blood smear image 300C. In an embodiment, the bimodal image may be determined by using a thresholding technique on the noise filtered blood smear image 300C. The thresholding technique may include, but is not limited to, triangle thresholding, TRUNC thresholding, Otsu thresholding, etc. In an embodiment, the thresholding technique may be used for segmenting the pixels of the noise filtered blood smear image 300C into two classes (i.e., foreground and background) by determining an optimal threshold value. Referring now to FIG. 3D, an exemplary bimodal blood smear image 300D is illustrated, in accordance with an embodiment of the present disclosure. In an embodiment, the noise filtered blood smear image 300C may be converted into the bimodal blood smear image 300D by using the thresholding technique. Due to the segmentation of the pixels of the noise filtered blood smear image 300C into foreground and background, the edges of each of the plurality of blood cells may be enhanced.

Referring back to FIG. 2, the edges of each of the plurality of blood cells may be determined based on the bimodal image 300D by using an edge detection technique. In an embodiment, the edge detection technique may include, but is not limited to, canny edge detection technique, sobel edge detection technique, scharr edge detection technique, etc. In an embodiment, the edge detection technique may be used to identify the edges of the plurality of blood cells within the bimodal image 300D by determining areas where there may be a significant change in intensity or color. Referring now to FIG. 3E, an exemplary edge detected blood smear image 300E is illustrated, in accordance with an embodiment of the present disclosure. In an embodiment, the edge detection technique may be used to detect edges in the bimodal blood smear image 300D.

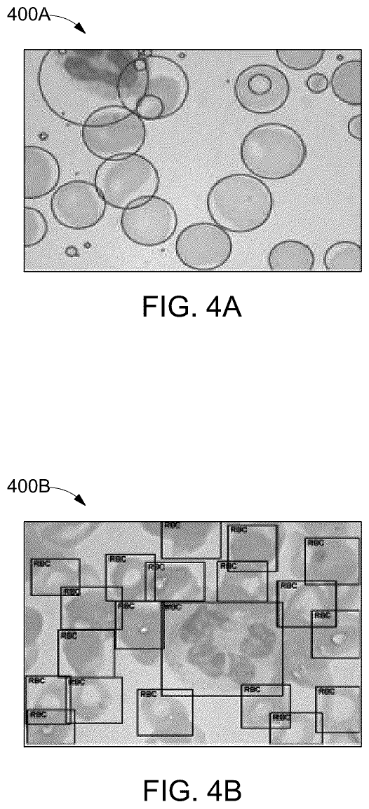

Referring back to FIG. 2, the contour determination module 206 may determine contours of each of the plurality of blood cells based on the edge detection of the plurality of blood-cells in the edge detected blood smear image 300E. The contour determination module 206 may trace boundaries of each of the plurality of blood cells in the edge detected blood smear image 300E by finding neighboring pixels in the image 300E that may be part of same edge and may form a closed contour. Referring now to FIG. 4A, an exemplary contour determined blood smear image 400A is illustrated, in accordance with an embodiment of the present disclosure. As depicted in the contoured blood smear image 400A, contours of the plurality of blood cells are shown in the edge detected blood smear image 300E. It may be noted that the contours are depicted as well-defined edges of cells having similar color intensity which may help in recognition of each of the plurality of blood cells in the blood smear image 300A.

Further, the bounding box determination module 208 may determine a bounding box for each of the plurality of blood-cell based on detection of the contours of each of the plurality of the blood cells in the contour determined blood smear image 400A. Referring now to FIG. 4B, an exemplary blood smear image 400B depicting bounding boxes around the detected plurality of blood cells is illustrated, in accordance with an embodiment of the present disclosure. The blood smear image 400B depicts the detected plurality of blood cells each being enclosed by a bounding box.

Referring back to FIG. 2, the blood cell classification module 210 may use a deep learning model 212 to classify each of the plurality of blood cells as one of a white blood cell (WBC) or a red blood cell (RBC). In an embodiment, the deep learning model may be, but not limited to, Generative Adversarial Network (GAN), External Classifier GAN, etc. In an embodiment, each of the plurality of blood-cells classified as a WBC, may be further classified as one of a plurality of WBC classes using the deep learning model 212. In an embodiment, each of the plurality of WBC classes may correspond to a type of WBC from a plurality of WBC types. In an embodiment, the WBC types may include, but not limited to, neutrophils, eosinophils, basophils, lymphocytes, and monocytes, etc.

In an embodiment, the deep learning model 212 may be trained by a training module 214 based on training data that may include a plurality of images of WBCs and RBCs. In an embodiment, the training module 214 may generate training data based on at least one training image. The at least one training image may include at least one WBC and/or at least one RBC. In general, blood smear images being used as a training image may include more number of RBCs than WBCs. In some scenarios, the blood smear image may include just one WBC or no WBCs. Accordingly, in order to train the deep learning model 212 a balanced number of images of the RBCs and WBCs may be required in order to have a balanced training dataset. In one embodiment, the training data may be balanced by the training module 214 by determining a balanced number of images of WBCs and RBCs. The at least one training image may be pre-processed by the pre-processing module 202 to enhance the contrast of the training image and remove noise from the contrast enhanced training image. Further, the WBCs and RBCs may be determined in the at least one training image by the blood cell detection module 204. Contours of the WBCs and RBCs may be determined in the at least one training image by the contour detection module 206. Further, bounding boxes for each of the at least one WBC and/or the at least one RBC may be determined based on detection of contours of the at least one WBC and the at least one RBC in the at least one training image. Further, each of the bounding boxes may be cropped and classified as RBC or WBC by the blood cell classification module 210. Accordingly, the training data may be determined to include at least one WBC image and at least one RBC image.

Further, the training module 214 may generate a plurality of images of RBCs and WBCs as training data by generating a first set of samples corresponding to WBCs and a second set of samples corresponding to RBCs based on the at least one WBC image and the at least one RBC image using a generator model of the deep learning model 212. The first set of samples and the second set of samples may be generated based on a classification of each sample as one of real sample or fake sample using a discriminator model of the deep learning model 212. The samples corresponding to the first set of samples and the second set of samples may be generated until the first set of samples may be balanced with respect to the second set of samples and each of the first set of samples and the second set of samples may be classified as real by the discriminator model. Accordingly, the training module 214 may determine the plurality of images of WBCs and RBCs based on the first set of samples and the second set of samples respectively. Accordingly, the training module 214 may ensure training of the deep learning model 212 based on a balanced training data. It is to be noted, the training of the deep learning model 212 based on the balanced training data may ensure accuracy in classification of the blood cells as WBCs or RBCs by the blood classification module 210.

Further, the report generation module 218 may output a report that may include a count of WBCs, a count of RBCs and/or a volumetric information of the RBCs and the WBCs in the blood smear image 300A. The count of WBCs, the count of RBCs may be determined based on the classification of each of the plurality of the blood cells as RBCs and WBCs by the blood classification module 210. In an embodiment, the report may include the count of WBCs, the count of RBCs and/or a volumetric information of the RBCs and the WBCs in the blood smear image 300A in a predefined text format.

Accordingly, the health analysis module 220 may sub-include a generative artificial intelligence-based application interface (API) 222. Further, the report output by the report generation module 218 in the predefined text format may be inputted as a query to the generative artificial intelligence-based query API 222. In an embodiment, the generative artificial intelligence-based query API 222 may be communicatively connected to a generative artificial intelligence-based server (not shown) such as, but not limited to, ChatGPT, etc. The analysing device 102 may further display an analysis received from the generative artificial intelligence-based query API 222 on a display screen. The analysis may be based on the count of WBCs, the count of RBCs or the volumetric information of the RBCs and WBCs in the blood smear image 300A. The analysis may be provided by the generative artificial intelligence-based server and may include one or more health conditions that may be determined based on a comparison of the count of WBCs, the count of RBCs or the volumetric information of the RBCs and the WBCs with a corresponding predefined threshold count of WBCs, a predefined threshold count of RBCs or a predefined volumetric threshold of RBCs and WBCs. In an exemplary embodiment, the analysis may list one or more health conditions such as, but not limited to, anemia, vitamin B-12 or folate deficiency, stomach ulcers, bleeding, lupus, hodgkin lymphoma, leukemia, multiple myeloma, etc. that may be caused in case the count of RBC is low than a normal range. In an exemplary embodiment, the analysis may list one or more health conditions such as, but not limited to, dehydration, lung diseases, heart diseases, kidney diseases, blood disorders, etc. that may be caused in case the count of RBC is high than a normal range. In an embodiment, the analysis may depict one or more health conditions that may affect the shape of the blood cells. In an embodiment, the shape of the blood cells may be determined based on the contour detection of the blood cells.

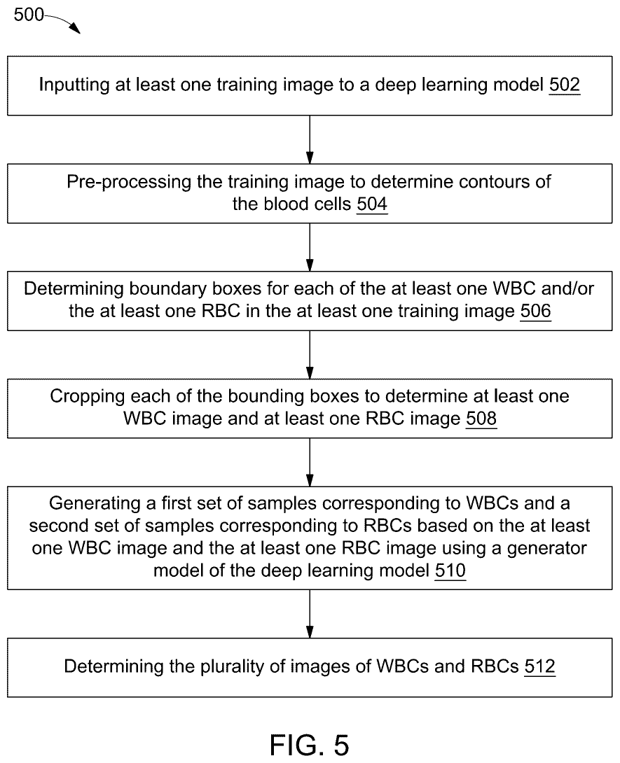

Referring now to FIG. 5, a flow diagram 500 of a methodology of generating training data is illustrated, in accordance with an embodiment of the present disclosure is illustrated. In an embodiment, the method 500 may include a plurality of steps that may be performed by the processor 104 to generate the training data.

At step 502, at least one training image may be inputted to a deep learning model 212. In an embodiment, one or more training images may be inputted to train the deep learning model 212. The one or more training images may include at least one WBC and/or at least one RBC. It is to be noted, that in order to train the deep learning model 212, at least one image of WBC and RBC may be inputted as training data. However, in order to avoid any bias in the deep learning model 212, the training data input is required to be balanced.

Further, at step 504, the at least one training image may be pre-processed to enhance contrast and remove noise in the at least one training image. Further, the at least one training image may be preprocessed to determine edges of blood cells in the at least one training image based on edge detection technique. Further, contours of the blood cells may be determined in the at least one training image based on contour detection technique.

Further, at step 506, boundary boxes may be determined based on the contours of the blood cells determined at step 505.

Further, at step 508, each of the boundary boxes may be cropped to determine at least one WBC image and at least one RBC image.

Further, at step 510, a first set of samples corresponding to WBCs and a second set of samples corresponding to RBCs may be generated based on the at least one WBC image and the at least one RBC image using a generator model of the deep learning model 212. In an embodiment, the first set of samples and the second set of samples may be generated may be fed to an external classification model and a discriminator model. The generator model may continue to generate one or more samples for the the first set of samples and the second set of samples until the discriminator model is about unable to distinguish between a real sample or a fake/generated sample. Accordingly, the external classification model may classify each sample as one of real sample or fake sample using the discriminator model of the deep learning model 212. Each of the samples corresponding to the first set of samples and the second set of samples may be generated by the generator model of the deep learning model 212 until the first set of samples may be balanced with respect to the second set of samples and each of the first set of samples and the second set of samples may be classified as real by the discriminator model of the deep learning model 212. Accordingly, at step 512, a plurality of images of WBCs and RBCs may be determined as balanced training data based on the first set of samples and the second set of samples respectively.

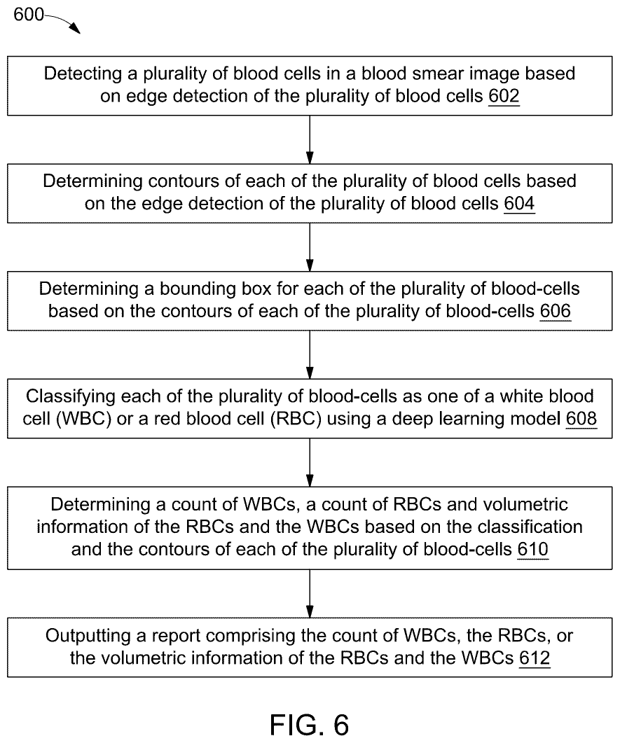

Referring now to FIG. 6, a flow diagram 600 of a methodology of analysing a blood smear image 300A, in accordance with some embodiment of the present disclosure is illustrated. In an embodiment, the flow diagram 600 may include a plurality of steps that may be performed by the processor 104 to analyze the blood smear image 300A.

At step 602, a plurality of blood cells in the blood smear image may be detected based on edge detection of the plurality of blood cells. In an embodiment, the edge detection of the plurality of blood cells in the blood smear image may be based on a preprocessing of the blood smear image. Further, at step 604, contours of each of the plurality of blood cells may be determined based on the edge detection of the plurality of blood-cells.

Further, at step 606, a bounding box for each of the plurality of blood cells may be determined based on the contours of each of the plurality of blood-cells. Further, at step 608, each of the plurality of blood-cells may be classified as one of a white blood cell (WBC) or a red blood cell (RBC) using the deep learning model 212. The deep learning model may be trained based on training data that may include a plurality of images of WBCs and RBCs. In an embodiment, the training data may be generated based on methodology described earlier in FIG. 5.

Further, at step 610, a count of WBCs, a count of RBCs and volumetric information of the RBCs and the WBCs may be determined based on the classification and the contours of each of the plurality of blood-cells. Further, at step 612, a report may be output that may include the count of WBCs, the count of RBCs or the volumetric information of the RBCs and the WBCs.

It is intended that the disclosure and examples be considered as exemplary only, with a true scope of disclosed embodiments being indicated by the following claims.

What is claimed is:

1. A method of analysing a blood smear image, the method comprising:
detecting, by a processor, a plurality of blood cells in the blood smear image based on edge detection of the plurality of blood cells,
wherein the edge detection of the plurality of blood cells in the blood smear image is based on a preprocessing of the blood smear image;
determining, by the processor, contours of each of the plurality of blood cells based on the edge detection of the plurality of blood-cells;
determining, by the processor, a bounding box for each of the plurality of blood-cells based on the contours of each of the plurality of blood-cells;
classifying, by the processor, each of the plurality of blood-cells as one of a white blood cell (WBC) or a red blood cell (RBC) using a deep learning model,
wherein the deep learning model is trained based on training data comprising a plurality of images of WBCs and RBCs;
determining, by the processor, a count of WBCs, a count of RBCs and volumetric information of the RBCs and the WBCs based on the classification and the contours of each of the plurality of blood-cells; and
outputting, by the processor, a report comprising the count of WBCs, the count of RBCs or the volumetric information of the RBCs and the WBCs.

2. The method of claim 1, wherein the preprocessing comprises:
enhancing contrast, by the processor, of the blood smear image using a histogram equalization technique; and
removing noise, by the processor, in the contrast enhanced blood smear image using a gaussian filter.

3. The method of claim 1, wherein the edges of each of the plurality of blood cells are determined by determining a bimodal image of the blood smear image upon the preprocessing, wherein the edges of each of the plurality of blood cells are determined based on the bimodal image by using an edge detection technique.

4. The method of claim 1, wherein the training data is generated by:
inputting, by the processor, at least one training image to the deep learning model,
wherein the at least one training image comprises at least one WBC and/or at least one RBC;
determining, by the processor, the plurality of images of WBCs and RBCs by:
determining, by the processor, bounding boxes for each of the at least one WBC and/or the at least one RBC based on detection of contours of the at least one WBC and the at least one RBC in the at least one training image;
cropping, by the processor, each of the bounding boxes to determine at least one WBC image and at least one RBC image;
generating, by the processor, a first set of samples corresponding to WBCs and a second set of samples corresponding to RBCs based on the at least one WBC image and the at least one RBC image respectively using a generator model of the deep learning model,
wherein the first set of samples and the second set of samples are generated based on a classification of each sample as one of real sample or fake sample using a discriminator model of the deep learning model,
wherein samples corresponding to the first set of samples and the second set of samples are generated until the first set of samples is balanced with respect to the second set of samples and each of the first set of samples and the second set of samples are classified as real by the discriminator model; and
wherein the plurality of images of WBCs and RBCs are determined based on the first set of samples and the second set of samples, respectively.

5. The method of claim 1, comprises:
inputting, by the processor, the report as a query to a generative artificial intelligence-based query system; and
displaying, by the processor, an analysis received from the generative artificial intelligence-based query system on a display screen.

6. The method of claim 5, wherein the analysis is based on the count of WBCs, the count of RBCs or the volumetric information of the RBCs and WBCs,
wherein the analysis comprises one or more health conditions determined based on a comparison of the count of WBCs, the count of RBCs or the volumetric information of the RBCs and the WBCs with a corresponding predefined threshold count of WBCs, a predefined threshold count of RBCs or a predefined volumetric threshold of RBCs and WBCs.

7. The method of claim 1, comprising:
classifying, by the processor, each of the plurality of blood-cells classified as the WBC as one of a plurality of WBC classes using the deep learning model, wherein each of the plurality of WBC classes correspond to a type of WBC from a plurality of WBC types.

8. A system of analysing a blood smear image, comprising:
a processor; and
a memory communicably coupled to the processor, wherein the memory stores processor-executable instructions, which, on executing by the processor, cause the processor to:
detect a plurality of blood cells in the blood smear image based on edge detection of the plurality of blood cells,
wherein the edge detection of the plurality of blood cells in the blood smear image is based on a preprocessing of the blood smear image;
determine contours of each of the plurality of blood cells based on the edge detection of the plurality of blood-cells;
determine a bounding box for each of the plurality of blood-cells based on the contours of each of the plurality of blood-cells;
classify each of the plurality of blood-cells as one of a white blood cell (WBC) or a red blood cell (RBC) using a deep learning model,
wherein the deep learning model is trained based on training data comprising a plurality of images of WBCs and RBCs;
determine a count of WBCs, a count of RBCs and volumetric information of the RBCs and the WBCs based on the classification and the contours of each of the plurality of blood-cells; and
output a report comprising the count of WBCs, the count of RBCs or the volumetric information of the RBCs and the WBCs.

9. The system of claim 8, wherein to preprocess, the processor is configured to:
enhance contrast of the blood smear image using a histogram equalization technique; and
remove noise in the contrast enhanced blood smear image using a gaussian filter.

10. The system of claim 8, wherein the edges of each of the plurality of blood cells are determined by determining a bimodal image of the blood smear image upon the preprocessing, wherein the edges of each of the plurality of blood cells are determined based on the bimodal image by using edge detection technique.

11. The system of claim 8, wherein to generate training data, the processor is configured to:
input at least one training image to the deep learning model,
wherein the at least one training image comprises at least one WBC and/or at least one RBC;
determine the plurality of images of WBCs and RBCs by:
determining bounding boxes for each of the at least one WBC and/or the at least one RBC based on detection of contours of the at least one WBC and the at least one RBC in the at least one training image;
cropping each of the bounding boxes to determine at least one WBC image and at least one RBC image;
generating a first set of samples corresponding to WBCs and a second set of samples corresponding to RBCs based on the at least one WBC image and the at least one RBC image using a generator model of the deep learning model,
wherein the first set of samples and the second set of samples are generated based on a classification of each sample as one of real sample or fake sample using a discriminator model of the deep learning model,
wherein samples corresponding to the first set of samples and the second set of samples are generated until the first set of samples is balanced with respect to the second set of samples and each of the first set of samples and the second set of samples are classified as real by the discriminator model; and
wherein the plurality of images of WBCs and RBCs are determined based on the first set of samples and the second set of samples respectively.

12. The system of claim 8, wherein the processor is configured to:
input the report as a query to a generative artificial intelligence-based query system; and
display an analysis received from the generative artificial intelligence-based query system on a display screen.

13. The system of claim 12, wherein the analysis is based on the count of WBCs, the count of RBCs or the volumetric information of the RBCs and WBCs,
wherein the analysis comprises one or more health conditions determined based on a comparison of the count of WBCs, the count of RBCs or the volumetric information of the RBCs and the WBCs with a corresponding predefined threshold count of WBCs, a predefined threshold count of RBCs or a predefined volumetric threshold of RBCs and WBCs.

14. The system of claim 8, wherein the processor is configured to:
Classify each of the plurality of blood-cells classified as the WBC as one of a plurality of WBC classes using the deep learning model, wherein each of the plurality of WBC classes correspond to a type of WBC from a plurality of WBC types.

15. A non-transitory computer-readable medium storing computer-executable instructions for analysing a blood smear image, the computer-executable instructions configured for:
detecting a plurality of blood cells in the blood smear image based on edge detection of the plurality of blood cells,
wherein the edge detection of the plurality of blood cells in the blood smear image is based on a preprocessing of the blood smear image;
determining contours of each of the plurality of blood cells based on the edge detection of the plurality of blood-cells;
determining a bounding box for each of the plurality of blood-cells based on the contours of each of the plurality of blood-cells;
classifying each of the plurality of blood-cells as one of a white blood cell (WBC) or a red blood cell (RBC) using a deep learning model,
wherein the deep learning model is trained based on training data comprising a plurality of images of WBCs and RBCs;
determining a count of WBCs, a count of RBCs and volumetric information of the RBCs and the WBCs based on the classification and the contours of each of the plurality of blood-cells; and
outputting a report comprising the count of WBCs, the count of RBCs or the volumetric information of the RBCs and the WBCs.

16. The non-transitory computer-readable medium of claim 15, wherein the computer executable instructions are configured to preprocess the blood smear image by:
enhancing contrast of the blood smear image using a histogram equalization technique; and
removing noise in the contrast enhanced blood smear image using a gaussian filter.

17. The non-transitory computer-readable medium of claim 15, wherein the edges of each of the plurality of blood cells are determined by determining a bimodal image of the blood smear image upon the preprocessing, wherein the edges of each of the plurality of blood cells are determined based on the bimodal image by using an edge detection technique.

18. The non-transitory computer-readable medium of claim 15, wherein the computer executable instructions are configured to generate the training data by:
inputting at least one training image to the deep learning mode,
wherein the at least one training image comprises at least one WBC and/or at least one RBC;
determining the plurality of images of WBCs and RBCs by:
determining bounding boxes for each of the at least one WBC and/or the at least one RBC based on detection of contours of the at least one WBC and the at least one RBC in the at least one training image;
cropping each of the bounding boxes to determine at least one WBC image and at least one RBC image;
generating a first set of samples corresponding to WBCs and a second set of samples corresponding to RBCs based on the at least one WBC image and the at least one RBC image respectively using a generator model of the deep learning model,
wherein the first set of samples and the second set of samples are generated based on a classification of each sample as one of real sample or fake sample using a discriminator model of the deep learning model,
wherein samples corresponding to the first set of samples and the second set of samples are generated until the first set of samples is balanced with respect to the second set of samples and each of the first set of samples and the second set of samples are classified as real by the discriminator model; and
wherein the plurality of images of WBCs and RBCs are determined based on the first set of samples and the second set of samples, respectively.

19. The non-transitory computer-readable medium of claim 15, wherein the computer executable instructions for:
inputting the report as a query to a generative artificial intelligence-based query system; and
displaying an analysis received from the generative artificial intelligence-based query system on a display screen.

20. The non-transitory computer-readable medium of claim 19, wherein the analysis is based on the count of WBCs, the count of RBCs or the volumetric information of the RBCs and WBCs, wherein the analysis comprises one or more health conditions determined based on a comparison of the count of WBCs, the count of RBCs or the volumetric information of the RBCs and the WBCs with a corresponding predefined threshold count of WBCs, a predefined threshold count of RBCs or a predefined volumetric threshold of RBCs and WBCs.
